(19) United States
(12) Patent Application Publication
(10) Pub. No.: US 2026/0054435 A1
(43) Pub. Date: Feb. 26, 2026

(54) SYSTEM WITH INTERCHANGEABLE INSERTS FOR MOLDING CUSTOMIZED MUD FLAPS

(71) Applicant: Trailer Aerodynamics LLC, Chicago, IL (US)

(72) Inventor: Justin K. Morgan, Anderson, SC (US)

(73) Assignee: Trailer Aerodynamics LLC, Chicago, IL (US)

(21) Appl. No.: 18/814,535

(22) Filed: Aug. 25, 2024

(51) Int. Cl. B29C 45/26; B29C 45/37; B29C 45/40; B29L 31/30; B62D 25/18

(52) U.S. Cl. CPC B29C 45/2673; B29C 45/2628; B29C 45/372; B29C 45/40; B62D 25/18; B29L 2031/3005

(57) ABSTRACT

A system for forming a mud flap includes a first section, a second section, and an interchangeable insert. The first section is for molding a front of the mud flap and defines a first surface and a first cavity. The second section is for molding a first portion of a rear of the mud flap and defines a second surface that is to abut the first surface, a receiver portion that is recessed relative to the second surface, and a second cavity. The interchangeable insert is to fit within the receiver portion and is for molding a first type of a second portion of the rear of the mud flap and defines a third surface that is to abut the first surface, and a third cavity that is to fluidly communicate with the first cavity and the second cavity and to form first indicia.

### TECHNICAL FIELD

This disclosure relates generally to a mud flap having molded-in indicia, and, for example, to a system having interchangeable inserts for molding the indicia (e.g., a brand name, logo, and/or the like) into the mud flap.

### BACKGROUND

A mud flap, also known as a splash guard or a mud guard, is an accessory for a vehicle that is designed to protect a trailing vehicle from road debris (e.g., mud, water, and/or the like) projected from tires of the vehicle during operation. Traditionally, a manufacturer will utilize a molding process (e.g., injection molding, compression molding, and/or the like) to produce the mud flap and later add a brand name, logo, or other indicia to the mud flap using a separate process such as pad printing, screen printing, hot stamping, and/or the like.

### SUMMARY

In some aspects, a method of forming a perforated mud flap is provided. The method includes providing a first mold section, providing a second mold section, and providing a mold insert. The first mold section is for molding a front face of the perforated mud flap, the first mold section defines a first parting surface and a first mold cavity. The second mold section is for molding a first portion of a rear face of the perforated mud flap, the second mold section defines a second parting surface and a second mold cavity, and includes a receiver portion that is recessed with respect to the second parting surface. The mold insert is configured to fit within the receiver portion, the mold insert defines a third parting surface and a third mold cavity for forming a second portion of the rear face of the perforated mud flap. The method further includes inserting the mold insert into the receiver portion, matingly engaging the first parting surface with the second parting surface and the third parting surface, thereby establishing fluid communication among the first mold cavity, the second mold cavity, and the third mold cavity, injecting polymer into the first mold cavity, the second mold cavity, and the third mold cavity, disengaging the first parting surface from the second parting surface and the third parting surface, and, removing the perforated mud flap. The perforated mud flap includes a plurality of perforations cooperatively formed by the first mold section and at least the mold insert and extending between the front face and the rear face. The rear face includes indicia that is formed by the mold insert.

The indicia may include an outline that is partially defined by a first subset of the plurality of perforations, and a continuity that is uninterrupted by the first subset of the plurality of perforations. A second subset of the plurality of perforations may be cooperatively formed by the first mold section and the second mold section. A third subset of the plurality of perforations may be cooperatively formed by the first mold section, the second mold section, and the mold insert. A depth of the receiver portion may be greater than a depth of the second mold cavity. The first mold cavity may include a first plurality of louver-forming portions, the second mold cavity may include a second plurality of louver-forming portions, the third mold cavity may include a third plurality of louver-forming portions, and the first plurality of louver-forming portions, the second plurality of louver-forming portions, and the third plurality of louver-forming portions may cooperate to form a plurality of louvers on the mud flap that are separated by the plurality of perforations. The third mold cavity may include louver-forming portions, and an indicia-forming portion that has a depth that is greater than a depth of the louver-forming portions.

The mold insert may be a first mold insert, the perforated mud flap may be a first perforated mud flap, the front face may be a first front face, the rear face may be a first rear face, the plurality of perforations may be a first plurality of perforations, and the indicia may be first indicia. The method may further include: removing the first mold insert from the receiver portion, providing a second mold insert configured to fit within the receiver portion, and inserting the second mold insert into the receiver portion. The second mold insert may define a fourth parting surface and a fourth mold cavity. The method may further include matingly engaging the first parting surface with the second parting surface and the fourth parting surface, thereby establishing fluid communication among the first mold cavity, the second mold cavity, and the fourth mold cavity, disengaging the first parting surface from the second parting surface and the fourth parting surface, and removing a second perforated mud flap. The second perforated mud flap may include a second front face, a second rear face, and a second plurality of perforations extending therebetween and cooperatively formed by the first mold section and at least the second mold insert. The second rear face may include second indicia that is formed by the second mold insert and that is different from the first indicia.

In other aspects, a perforated mud flap is provided that is formed by injection of a polymer into a first mold cavity of a first mold section, a second mold cavity of a second mold section, and a third mold cavity of a mold insert that is seated within a received portion of the second mold section. The perforated mud flap includes a front face, a rear face, and a plurality of perforations extending between the front face and the rear face. The rear face includes indicia and a witness line. The indicia is formed by solidification of the polymer in an indicia-forming portion of the third mold cavity. The witness line at least partially surrounds the indicia and is formed by solidification of the polymer in a gap between an outer edge of the mold insert and a perimeter of the receiver portion. A first subset of the plurality of perforations partially defines an outline of the indicia and does not interrupt a continuity of the indicia.

The perforated mud flap may be a monolithic, one-piece structure. The plurality of perforations may extend in a horizontal direction of the perforated mud flap. The perforated mud flap may further include a plurality of louvers that are separated by the plurality of perforations and are formed by solidification of the polymer in the first mold cavity, the second mold cavity, and the third mold cavity. A heigh of the witness line may be less than a depth of a louver, of the plurality of louvers. A second subset of the plurality of perforations may bridge a first portion of the perforated mud flap that is external to the witness line and a second portion of the perforated mud flap that is internal to the witness line. The perforated mud flap may further include a plurality of louvers and a plurality of strengthening members that are separated by the plurality of perforations and formed by solidification of the polymer in the first mold cavity, the second mold cavity, and the third mold cavity.

In other aspects, a system for forming a mud flap having a plurality of perforations is provided. The system includes a first mold section, a second mold section, a first mold insert, and a second, alternative mold insert. The first mold section is for molding a front face of the mud flap and defines a first parting surface and a first mold cavity. The second mold section is for molding a first portion of a rear face of the mud flap and defines a second parting surface that is configured to abut the first parting surface, a receiver portion that is recessed with respect to the second parting surface, and a second mold cavity. The first mold insert is configured to fit within the receiver portion and is for molding a first type of a second portion of the rear face of the mud flap. The first mold insert defines a third parting surface that is configured to abut the first parting surface, and a third mold cavity that is configured to fluidly communicate with the first mold cavity and to form first indicia that has a first outline that is partially defined by a first subset of the plurality of perforations. The second, alternative mold insert configured to fit within the receiver portion and for molding a second type of the second portion of the rear face of the mud flap. The second, alternative mold insert defines a fourth parting surface that is configured to abut the first parting surface, and a fourth mold cavity that is configured to fluidly communicate with the first mold cavity and the second mold cavity and is to form second indicia that is different than the first indicia. The second indicia has a second outline that is partially defined by a second subset of the plurality of perforations.

When the first mold insert is inserted into the receiver portion, a gap may be defined between an outer edge of the first mold insert and a perimeter of the receiver portion. During molding, the gap may form a witness line on the rear surface of the mud flap that at least partially surrounds the first indicia. When the second, alternative mold insert is inserted into the receiver portion, a gap may be defined between an outer edge of the second, alternative mold insert and a perimeter of the receiver portion. During mold, the gap forms a witness line on the rear face of the mud flap that at least partially surrounds the second indicia. The first indicia and the second indicia, when formed, are continuous and uninterrupted by any of the plurality of perforations. The first mold cavity may include a first plurality of angled portions, the second mold cavity may include a second plurality of angled portions, the third mold cavity may include a third plurality of angled portions, and the fourth mold cavity may include a fourth plurality of angled portions. The first plurality of angled portions, the second plurality of angled portions, and one of the third plurality of angled portions and the fourth plurality of angled portions may cooperated to form a plurality of angled strengthening members on the mud flap. The first mold cavity may include a first plurality of louver-forming portions, the second mold cavity may include a second plurality of louver-forming portions, the third mold cavity may include a third plurality of louver-forming portions, and the fourth mold cavity may include a fourth plurality of louver-forming portions. The first plurality of louver-forming portions, the second plurality of louver-forming portions, and one of the third plurality of louver-forming portions and the fourth plurality of louver-forming portions may cooperate to form a plurality of louvers on the mud flap that are separated by the plurality of perforations.

### BRIEF DESCRIPTION OF DRAWINGS

FIG. 1 is an isometric view of an example mud flap having first indicia, in accordance with one or more aspects of the present disclosure.

FIG. 2 is a rear view of the mud flap of FIG. 1.

FIG. 3 is a front view of the mud flap of FIG. 1.

FIG. 4 is a rear view of an example mud flap having second indicia, in accordance with one or more aspects of the present disclosure.

FIG. 5 is an isometric view of an example system for molding the mud flap with the first indicia or the second indicia, in accordance with one or more aspects of the present disclosure.

FIG. 6 is an isometric view of an example mold insert and an example mold section being attached with a first arrangement of fasteners, in accordance with one or more aspects of the present disclosure.

FIG. 7 is another isometric view of the mold insert and the mold section being attached with the first arrangement of fasteners of FIG. 6.

FIG. 8 is an isometric view of an example mold insert and an example mold section being attached with a second arrangement of fasteners, in accordance with one or more aspects of the present disclosure.

FIG. 9 is another isometric view of the mold insert and the mold section being attached with the second arrangement of fasteners of FIG. 8.

Before any exemplary configurations of the disclosure are explained in detail, it is to be understood that the disclosure is not limited in its application to the details of construction and the arrangement of components set forth in the following description or illustrated in the accompanying drawings. The disclosure is capable of other configurations and of being practiced or of being carried out in various ways. Also, it is to be understood that the phraseology and terminology used herein is for the purpose of description and should not be regarded as limiting.

### DETAILED DESCRIPTION

This disclosure relates to a mud flap having molded-in, customizable indicia and a system with interchangeable inserts for molding the mud flap. In use, the mud flap may be attached to a vehicle (e.g., a trailer, a truck, a sport utility vehicle, and/or the like) to prevent road debris (e.g., rocks, mud, water, and/or the like), which may be scattered by tires of the vehicle, from striking a trailing vehicle.

To simplify explanation below, the same reference numbers may be used to denote the same or similar features. The drawings may not be to scale.

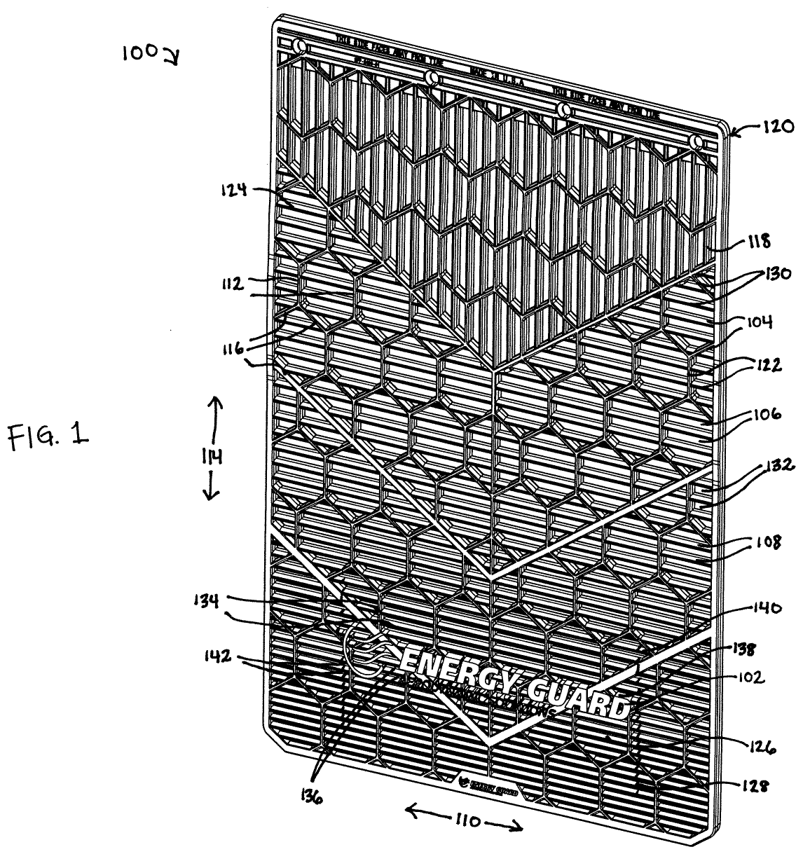

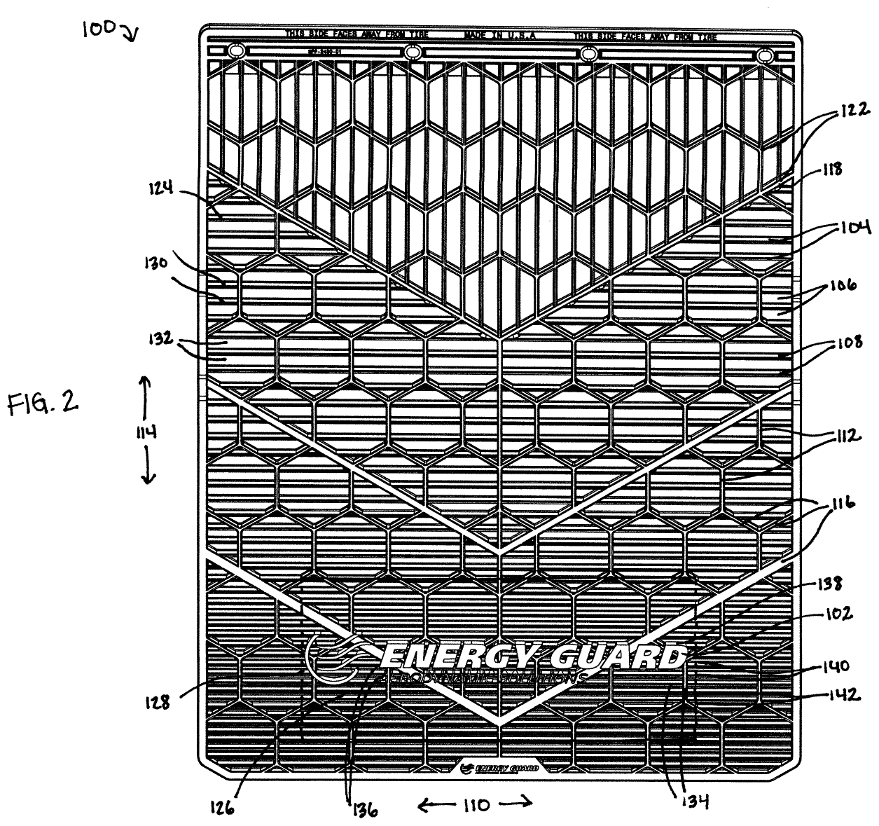

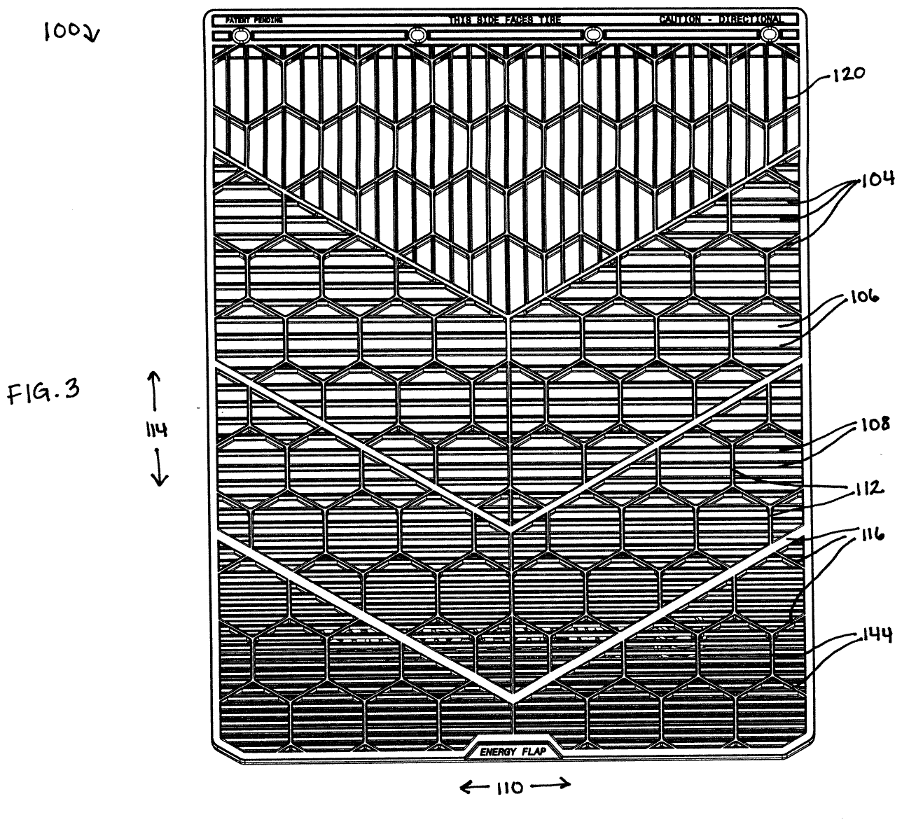

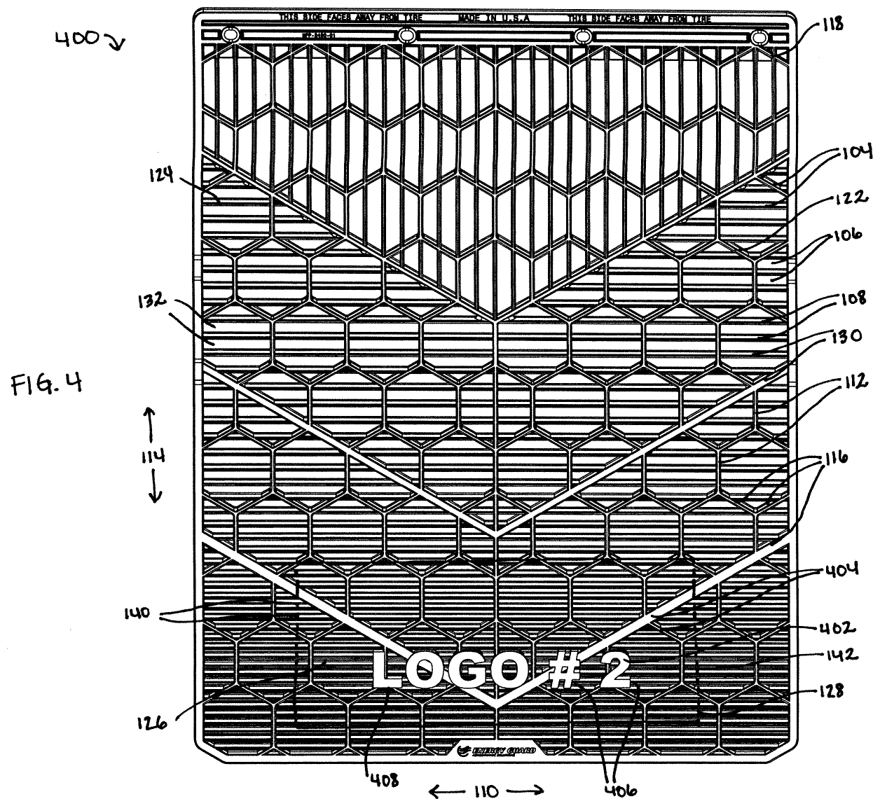

FIGS. 1-3 illustrate an example mud flap 100 having first indicia 102, and, to illustrate the customizability of the present disclosure, FIG. 4 illustrates an example mud flap 400 having second indicia 402 that is different than the first indicia 102. While the first indicia 102 and the second indicia 402 are shown as alternative example logos, it should be understood that other types of indicia (e.g., design elements, branding, arrangements of alphanumeric characters, and/or the like) may be provided for marketing, aesthetic, or other reasons.

In the examples shown in FIGS. 1-4, it should first be understood that the mud flap 100 and the mud flap 400 each have a complex structure that includes a plurality of barrier elements 104 separated by a plurality of perforations 106. The plurality of barrier elements 104 are configured to intercept and deflect road debris. The plurality of perforations 106, in turn, are configured to permit airflow through the mud flap 100, 400. The precise structure and arrangement of the plurality of barrier elements 104 and the plurality of perforations 106 may be optimized to balance both protective features and aerodynamic features of the mud flap 100, 400.

For example, as shown in FIGS. 1-4, the plurality of barrier elements 104 may include a plurality of louvers 108, which extend in a horizontal direction 110 of the mud flap 100, a plurality of vertical strengthening members 112, which extend in a vertical direction 114 of the mud flap 100, and a plurality of angled strengthening members 116, which extend at an angle relative to the horizontal direction 110. To enhance aerodynamic performance of the mud flap 100, 400, the plurality of louvers 108 may be spaced apart in the vertical direction 114 such that spacing between adjacent louvers 108, of the plurality of louvers 108, increases with increasing elevation along the vertical direction 114. In other words, spacing between adjacent louvers 108, that are closer to a top of the mud flap than other adjacent louvers 108, is larger than spacing between the other adjacent louvers 108. Furthermore, to maximize the protective capability of the mud flap 100, 400, each louver 108, of the plurality of louvers 108, may be oriented and arranged relative to an adjacent tire of the vehicle to substantially prevent see-through openings between the plurality of louvers 108 when viewed along tangent lines of the adjacent tire. For example, each louver 108, of the plurality of louvers 108, may be angled such that a rear louver surface (of the rear barrier surfaces 122, detailed below) is at a lower elevation, in the vertical direction 114, than a front louver surface (of the front barrier surfaces 144, detailed below). To provide structural integrity and durability to the mud flap 100, 400, at least some of the vertical strengthening members 112 and the angled strengthening members 116 may be arranged to form hexagonal shapes in a honeycomb-like pattern. Additionally, or alternatively, at least some of the angled strengthening members 116 may be arranged to form a chevron that extends across a width of the mud flap 100, 400.

In FIGS. 1-3, the mud flap 100 includes a rear face 118 and a front face 120, with the plurality of perforations 106 extending therebetween. The rear face 118 is configured to face away from tires of the vehicle to which the mud flap 100 is attached and is defined in part by rear barrier surfaces 122 of the plurality of barrier elements 104.

The rear face 118 includes a first portion 124, a second portion 126, and a witness line 128, which is by-product of the injection molding process, described below, and that defines a demarcation between the first portion 124 and the second portion 126. The first portion 124 includes a first subset 130 of the rear barrier surfaces 122 and a first subset 132 of the plurality of perforations 106. The second portion 126 includes a second subset 134 of the rear barrier surfaces 122, a second subset 136 of the plurality of perforations 106, and the first indicia 102. The first indicia 102 includes an outline 138 that is partially defined by the second subset 136 of the plurality of perforations 106 and a continuity that is uninterrupted by the second subset 136 of the plurality of perforations 106. In other words, each portion of the first indicia 102 is a solid structure that is directly connected to the second subset 134 of the rear barrier surfaces 122. The witness line 128 at least partially surrounds the first indicia 102, extends over a third subset 140 of the rear barrier surfaces 122, and is interrupted by a third subset 142 of the plurality of perforations 106 that bridge the first portion 124 and the second portion 126. For reasons related to the manufacturing process, which will be described below, the first indicia 102 rearwardly protrudes from the second subset 134 of the rear barrier surfaces 122 (e.g., to facilitate application of colored ink, if desired, and/or the like) and has a depth that is less than a depth of the plurality of barrier elements 104. However, in some implementations, the first indicia 104 may be flush with the second subset 134 of the rear barrier surfaces 122 or recessed relative to the second subset 134 of rear barrier surfaces.

The front face 120 is configured to face the tires of the vehicle to which the mud flap 100 is attached and is defined by front barrier surfaces 144 of the plurality of barrier elements 104. Except for the exclusion of the first indicia 102, the exclusion of the witness line 128, and different angular positioning of the front barrier surfaces 144 of the plurality of louvers 108 compared to that of the rear barrier surfaces 122 of the plurality of louvers 108, the structure of the front face 120 may be substantially the same as the structure of the rear face 118.

In FIG. 4, the mud flap 400 has substantially the same structure as the mud flap 100, with the primary, and in some cases the only, difference relating to the second indicia 402. As discussed above, the rear face 118 includes a first portion 124, a second portion 126, and a witness line 128 that defines a demarcation between the first portion 124 and the second portion 126. Because the second portion 126 includes the second indicia 402, instead of the first indicia 102, the second portion 126 includes a fourth subset 404 of the rear barrier surfaces 122 that is different from the second subset 134 of the rear barrier surfaces 122, and a fourth subset 406 of the plurality of perforations 106 that is different than the second subset 136 of the plurality of perforations 106. The second indicia 402 includes a second outline 408 that is partially defined by the fourth subset 406 of the plurality of perforations 106 and a continuity that is uninterrupted by the fourth subset 406 of the plurality of perforations 106. In other words, each portion of the second indicia 402 is a solid structure that is directly connected to the fourth subset 404 of the rear barrier surfaces 122. For reasons related to the manufacturing process, which will be described below, the second indicia 402 rearwardly protrudes from the fourth subset 404 of the rear barrier surfaces 122 (e.g., to facilitate application of colored ink, if desired, and/or the like) and has a depth that is less than a depth of the plurality of barrier elements 104. However, in some implementations, the second indicia may be flush with the fourth subset 404 of rear barrier surfaces 122 or recessed relative to the fourth subset 404 of the rear barrier surfaces.

As indicated above, FIGS. 1-4 are provided as examples. Other examples may differ from what is described with regard to FIGS. 1-4. For example, the mud flap 100 and/or the mud flap 400 may include additional barrier elements, fewer barrier elements, differently shaped barrier elements, and differently arranged barrier elements than those shown in FIGS. 1-4.

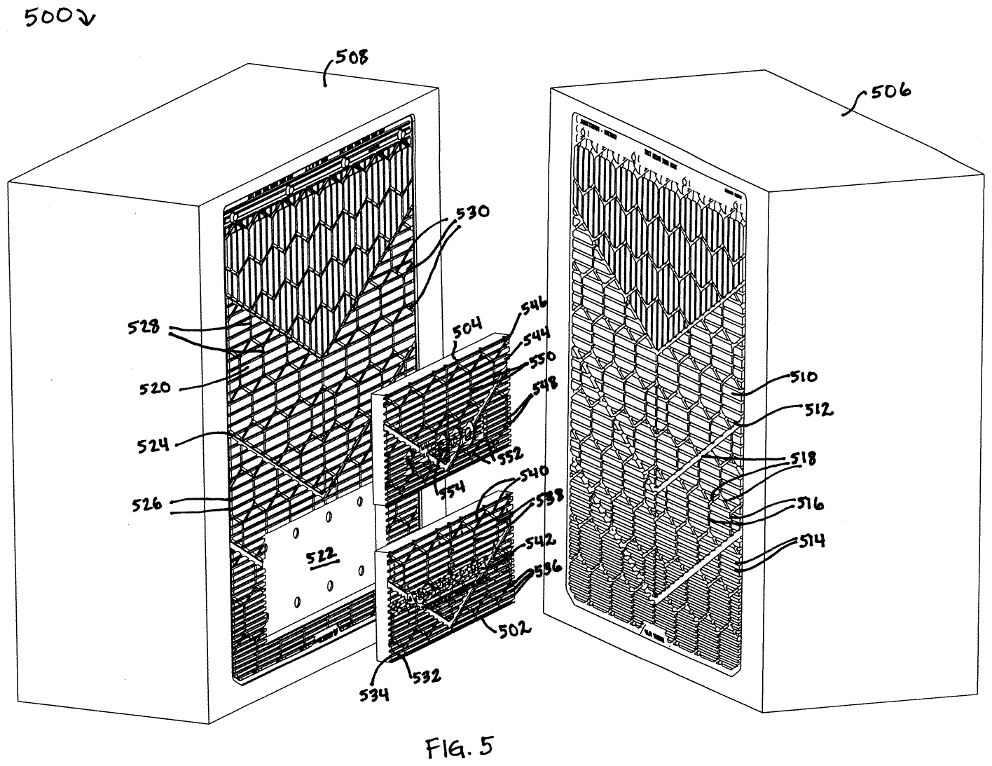

FIG. 5 illustrates an example system 500 for molding the mud flap 100 and/or the mud flap 400. For illustrative purposes, the system 500 is shown as having a first mold insert 502, for molding the second portion 126 of the rear face 118 of the mud flap 100 (including the first indicia 102), and a second mold insert 504, for molding the second portion 126 of the rear face 118 of the mud flap 400 (including the second indicia 402). However, it should be understood that the system 500 may include any number of different, interchangeable mold inserts, and that the first mold insert 502 and the second mold insert 504 may be produced at different times (e.g., depending on design needs, branding needs, and/or the like).

In addition to including the first mold insert 502 and the second mold insert 504, the system 500 includes a first mold section 506, for molding the front face 120 of the mud flap 100, 400, and a second mold section 508, for molding the first portion 124 of the rear face 118 of the mud flap 100, 400. The first mold section 506 defines a first parting surface 510 and a first mold cavity 512. The first mold cavity 512 includes a first plurality of louver-forming portions 514, a first plurality of vertical portions 516, and a first plurality of angled portions 518. The second mold section 508 defines a second parting surface 520, a receiver portion 522 that is recessed with respect to the second parting surface 520, and a second mold cavity 524. The receiver portion 522, which has a depth that is greater than a depth of the second mold cavity 524, is configured to receive, individually, the first mold insert 502 or the second mold insert 504. The second mold cavity 524 includes a second plurality of louver-forming portions 526, a second plurality of vertical portions 528, and a second plurality of angled portions 530.

The first mold insert 502 defines a third parting surface 532 and a third mold cavity 534. The third mold cavity 534 includes a third plurality of louver-forming portions 536, a third plurality of vertical portions 538, a third plurality of angled portions 540, and a first indicia-forming portion 542. The first indicia-forming portion 524 has a depth that is greater than any of the third plurality of louver-forming portions 536, the third plurality of vertical portions 538, and the third plurality of angled portions 540. The second mold insert 504, which has substantially the same shape and size as the first mold insert 502, defines a fourth parting surface 544 and a fourth mold cavity 546. The fourth mold cavity 546 includes a fourth plurality of louver-forming portions 548, a fourth plurality of vertical portions 550, a fourth plurality of angled portions 552, and a second indicia-forming portion 554 that is different than the first indicia-forming portion 542. The second indicia-forming portion 554 has a depth that is greater than any of the fourth plurality of louver-forming portions 548, the fourth plurality of vertical portions 550, and the fourth plurality of angled portions 552.

As indicated above, FIG. 5 is provided as an example. Other examples may differ from what is described with regard to FIG. 5. It should be understood that the first mold section 506 and/or the second mold section 508 may have additional features known in the injection molding art, such as a sprue bushing, a locating ring, one or more cooling channels, one or more ejector pins, one or more spacer blocks, and/or the like. Furthermore, the precise shape of the first mold cavity 512, the second mold cavity 524, the third mold cavity 534, and/or the fourth mold cavity 546 are provided as examples and may be altered to produce mud flaps having different aerodynamic features, different protective features, and/or the like.

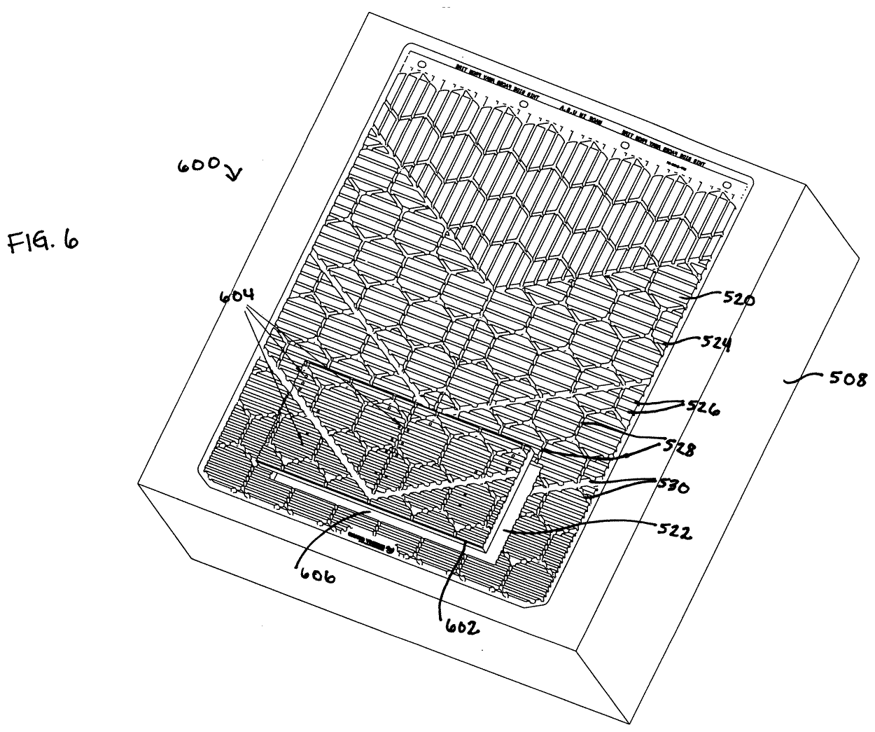

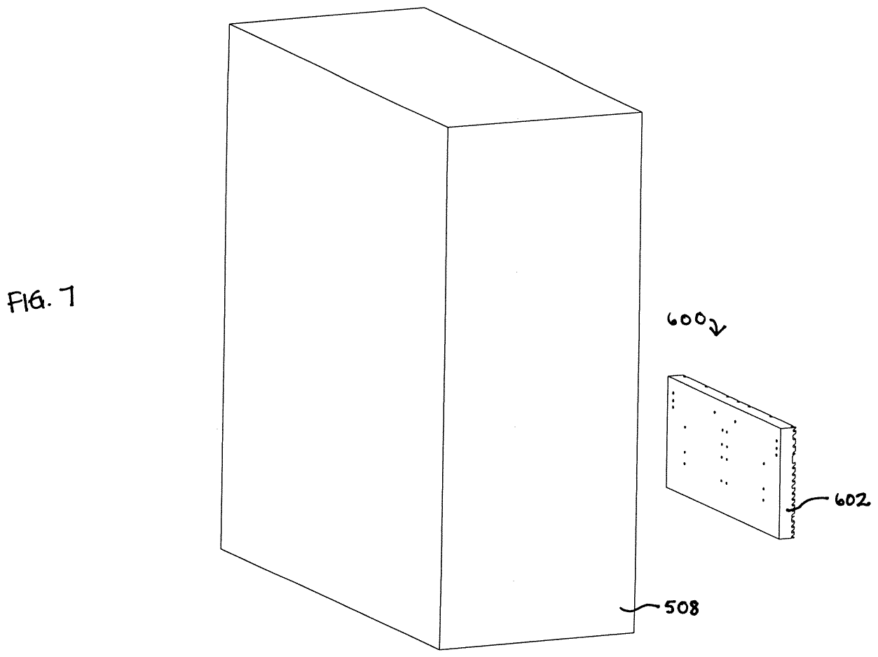

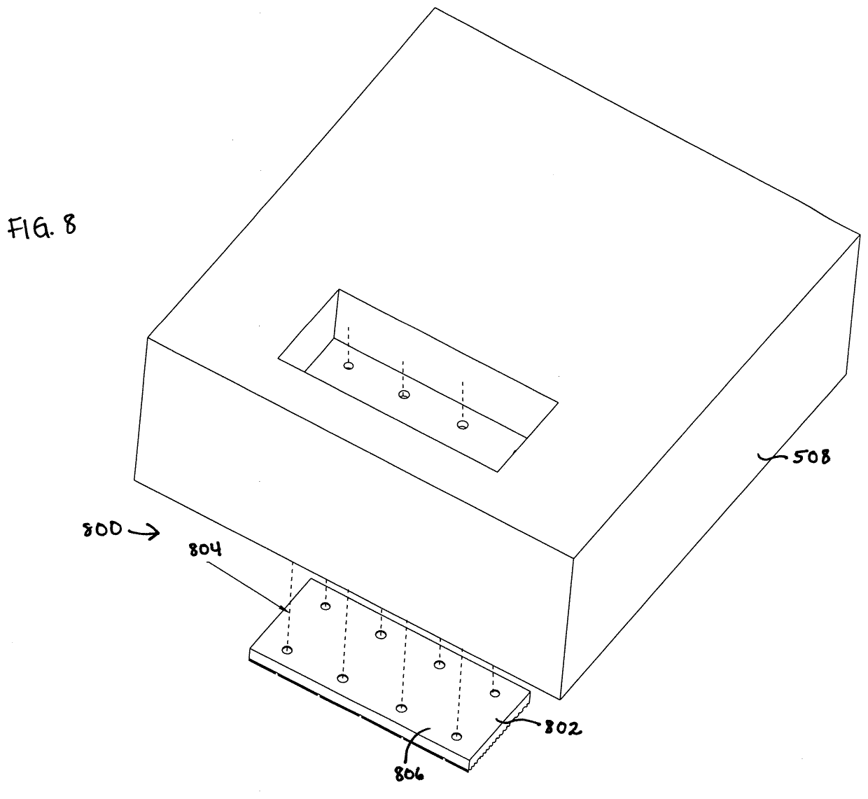

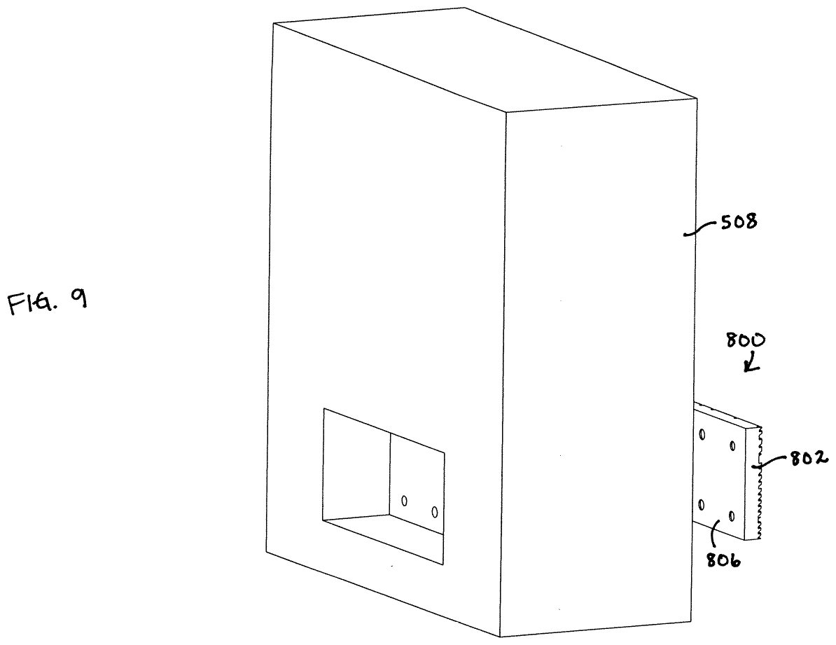

FIGS. 6-7 illustrate a first fastener arrangement 600 for securing a mold insert 602 within the receiver portion 522 of the second mold section 508. In the first fastener arrangement 600, a plurality of fasteners 604 (e.g., screws, bolts, pins, and/or the like) extend through the mold insert 602 and into a front surface 606 of the second mold section 508. FIGS. 8-9 illustrate a second fastener arrangement 800 for securing a mold insert 802 within the receiver portion 522 of the second mold section 508. In the second fastener arrangement 800, a plurality of fasteners 804 (e.g., screws, bolts, pins, and/or the like) extend through the second mold section 508 and into a rear surface 806 of the mold insert 802. It should be understood that the mold insert 602 and the mold insert 802 may each represent the first mold insert 502, the second mold insert 504, or a different mold insert (e.g., one having no indicia, one having different indicia, and/or the like).

FIGS. 6-9 are provided as examples. Other examples may differ from what is described with regard to FIGS. 6-9.

An example use of the system 500 will now be described. First, assume that a user has chosen to produce the mud flap 100. After producing the first mold section 506, the second mold section 508, and the first mold insert 502 (e.g., using computer-aided design (CAD) software, computer numerical control (CNC) machining, electric discharge machining (EDM), surface finishing techniques, and/or the like), the user may insert the first mold insert 502 into the receiver portion 522 of the second mold section 508. Because the receiver portion 522 must be formed with sufficient clearance to allow the first mold insert 502 to be inserted therein and removed therefrom, when the first mold insert 502 is inserted in the receiver portion 522, a gap is formed between an outer edge of the first mold insert 502 and a perimeter of the receiver portion 522. The user may then secure the first mold insert 502 in place using the first fastener arrangement 600, the second fastener arrangement, and/or the like. The user may then clamp the first mold section 506 and the second mold section 508 together, causing the first parting surface 510 to matingly engage with the second parting surface 520 and the third parting surface 532, establishing fluid communication among the first mold cavity 512, the second mold cavity 524, and the third mold cavity 534 (hereinafter collectively referred to as “the mold cavities”). With the first mold section 506 and the second mold section 508 so engaged, the user may then inject polymer into the mold cavities. As the polymer fills in the mold cavities, the polymer takes the shape of the plurality of barrier elements 104 and the first indicia 102. In addition, the gap between the first mold insert 502 and the receiver portion 522 results in formation of the witness line 128. The prominence of the witness line 128 will vary based on the tolerances and the resulting size and shape of the gap between the first mold insert 502 and the receiver portion 522. However, it will generally be the case that a height of the witness line 128 will be less than a depth of any of the plurality of barrier elements 104.

With respect to the mold cavities, the first plurality of louver-forming portions 514, the second plurality of louver-forming portions 526, and the third plurality of louver-forming portions 536, once filled with the polymer, cooperate to form the plurality of louvers 108. Furthermore, the first plurality of vertical portions 516, the second plurality of vertical portions 528, and the third plurality of vertical portions 538, once filled with the polymer, cooperate to form the plurality of vertical strengthening members 112. Further still, the first plurality of angled portions 518, the second plurality of angled portions 530, and the third plurality of angled portions 540, once filled with the polymer, cooperate to form the plurality of angled strengthening members 116. After the polymer solidifies and cools, the user may separate the first mold section 506 and the second mold section 508, thereby causing the first parting surface 510 to disengage from the second parting surface 520 and the third parting surface 532. The user may then remove the mud flap 100 as a monolithic, one-piece structure, and install the mud flap 100 onto a vehicle as desired.

Next, assume that the user has chosen to produce the mud flap 400. Because the first mold section 506 the second mold section 508 have already been made and are usable with any mold insert sized to fit within the receiver portion 522, the user need only produce a new mold insert (e.g., in this example, the second mold insert 504) to create a mud flap having a different design (e.g., in this example, the mud flap 400). After the user removes the first mold insert 502 from the receiver portion 522, the user insert the second mold insert 504 into the receiver portion 522, once again resulting in a gap between an outer edge of the second mold insert 504 and a perimeter of the receiver portion 522. The user may then secure the second mold insert 504 in place using the first fastener arrangement 600, the second fastener arrangement, and/or the like. The user may then clamp the first mold section 506 and the second mold section 508 together, causing the first parting surface 510 to matingly engage with the second parting surface 520 and the fourth parting surface 544, establishing fluid communication among the first mold cavity 512, the second mold cavity 524, and the fourth mold cavity 546 (hereinafter collectively referred to as “the mold cavities”). With the first mold section 506 and the second mold section 508 so engaged, the user may then inject polymer into the mold cavities. As the polymer fills in the mold cavities, the polymer takes the shape of the plurality of barrier elements 104 and the second indicia 402. In addition, as described above, the gap between the second mold insert 504 and the receiver portion 522 results in formation of the witness line 128. The prominence of the witness line 128 will vary based on the tolerances and the resulting size and shape of the gap between the second mold insert 504 and the receiver portion 522. However, it will generally be the case that a height of the witness line 128 will be less than a depth of any of the plurality of barrier elements 104.

With respect to the mold cavities, the first plurality of louver-forming portions 514, the second plurality of louver-forming portions 526, and the fourth plurality of louver-forming portions 548, once filled with the polymer, cooperate to form the plurality of louvers 108. Furthermore, the first plurality of vertical portions 516, the second plurality of vertical portions 528, and the fourth plurality of vertical portions 550, once filled with the polymer, cooperate to form the plurality of vertical strengthening members 112. Further still, the first plurality of angled portions 518, the second plurality of angled portions 530, and the fourth plurality of angled portions 552, once filled with the polymer, cooperate to form the plurality of angled strengthening members 116. After the polymer solidifies and cools, the user may separate the first mold section 506 and the second mold section 508, thereby causing the first parting surface 510 to disengage from the second parting surface 520 and the fourth parting surface 544. The user may then remove the mud flap 400 as a monolithic, one-piece structure, and install the mud flap 400 onto a vehicle as desired.

By utilizing interchangeable mold inserts (e.g., the first mold insert 502, the second mold insert 504, and/or the like) to produce molded-in indicia (e.g., logos, design elements, branding, arrangements of alphanumeric characters, and/or the like), the present disclosure sets forth a number of advantages over prior art processes, which include pad printing, screen printing, and hot stamping. The prior art processes, in the context of mud flaps, all involve depositing material onto a surface of the mud flap. Pad printing and screen printing both deposit ink, and hot stamping deposits a foil. In each case, the deposited material is different than that of the mud flap, sits only on a surface of the mud flap (which may cause the indicia to be interrupted by perforations or other surface textures of the mud flap), and has a tendency to fade over time. In contrast to those deficiencies, the indicia of the present disclosure forms a structural, solid component of the mud flap that is uninterrupted by any perforations in the mud flap and that may be more easily viewable and more durable than indicia created by the prior art processes. Furthermore, by molding in the indicia such that an outline of the indicia is defined by a subset of the barrier elements and a subset of the perforations (rather than, say, providing the indicia on a solid block of the mud flap), the user may maintain the aerodynamic properties of the mud flap while also providing clearly visible and durable indicia. Furthermore, by utilizing interchangeable mold inserts, the present disclosure greatly conserves cost and manufacturing resources that would otherwise be wasted producing entirely new mold sections to generate different indicia.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A method of forming a perforated mud flap, the method comprising:
providing a first mold section for molding a front face of the perforated mud flap, the first mold section defining a first parting surface and a first mold cavity;
providing a second mold section for molding a first portion of a rear face of the perforated mud flap, the second mold section defining a second parting surface and a second mold cavity, and including a receiver portion that is recessed with respect to the second parting surface;
providing a mold insert configured to fit within the receiver portion, the mold insert defining a third parting surface and a third mold cavity for forming a second portion of the rear face of the perforated mud flap;
inserting the mold insert into the receiver portion;
matingly engaging the first parting surface with the second parting surface and the third parting surface, thereby establishing fluid communication among the first mold cavity, the second mold cavity, and the third mold cavity;
injecting polymer into the first mold cavity, the second mold cavity, and the third mold cavity;
disengaging the first parting surface from the second parting surface and the third parting surface; and,
removing the perforated mud flap, wherein the perforated mud flap includes a plurality of perforations cooperatively formed by the first mold section and at least the mold insert and extending between the front face and the rear face, and wherein the rear face includes indicia that is formed by the mold insert.

2. The method of claim 1, wherein the indicia includes:
an outline that is partially defined by a first subset of the plurality of perforations, and
a continuity that is uninterrupted by the first subset of the plurality of perforations.

3. The method of claim 1, wherein a second subset of the plurality of perforations are cooperatively formed by the first mold section and the second mold section.

4. The method of claim 1, wherein a third subset of the plurality of perforations are cooperatively formed by the first mold section, the second mold section, and the mold insert.

5. The method of claim 1, wherein a depth of the receiver portion is greater than a depth of the second mold cavity.

6. The method of claim 1, wherein the first mold cavity includes a first plurality of louver-forming portions,
wherein the second mold cavity includes a second plurality of louver-forming portions,
wherein the third mold cavity includes a third plurality of louver-forming portions, and
wherein the first plurality of louver-forming portions, the second plurality of louver-forming portions, and the third plurality of louver-forming portions cooperate to form a plurality of louvers on the mud flap that are separated by the plurality of perforations.

7. The method of claim 1, wherein the third mold cavity includes:
louver-forming portions, and
an indicia-forming portion that has a depth that is greater than a depth of the louver-forming portions.

8. The method of claim 1, wherein the mold insert is a first mold insert, the perforated mud flap is a first perforated mud flap, the front face is a first front face, the rear face is a first rear face, the plurality of perforations are a first plurality of perforations, and the indicia is first indicia; and
wherein the method further comprises:
removing the first mold insert from the receiver portion;
providing a second mold insert configured to fit within the receiver portion, the second mold insert defining a fourth parting surface and a fourth mold cavity;
inserting the second mold insert into the receiver portion;
matingly engaging the first parting surface with the second parting surface and the fourth parting surface, thereby establishing fluid communication among the first mold cavity, the second mold cavity, and the fourth mold cavity;
injecting polymer into the first mold cavity, the second mold cavity, and the fourth mold cavity;
disengaging the first parting surface from the second parting surface and the fourth parting surface; and,
removing a second perforated mud flap, wherein the second perforated mud flap includes a second front face, a second rear face, and a second plurality of perforations extending therebetween and cooperatively formed by the first mold section and at least the second mold insert, and wherein the second rear face includes second indicia that is formed by the second mold insert and that is different from the first indicia.

9. A perforated mud flap formed by injection of a polymer into a first mold cavity of a first mold section, a second mold cavity of a second mold section, and a third mold cavity of a mold insert that is seated within a receiver portion of the second mold section, the perforated mud flap comprising:
a front face;
a rear face including:
indicia formed by solidification of the polymer in an indicia-forming portion of the third mold cavity, and
a witness line at least partially surrounding the indicia and formed by solidification of the polymer in a gap between an outer edge of the mold insert and a perimeter of the receiver portion; and
a plurality of perforations extending between the front face and the rear face, wherein a first subset of the plurality of perforations partially defines an outline of the indicia and does not interrupt a continuity of the indicia.

10. The perforated mud flap of claim 9, wherein the perforated mud flap is a monolithic, one-piece structure.

11. The perforated mud flap of claim 9, wherein the plurality of perforations extend in a horizontal direction of the perforated mud flap.

12. The perforated mud flap of claim 9, further comprising:
a plurality of louvers that are separated by the plurality of perforations and formed by solidification of the polymer in the first mold cavity, the second mold cavity, and the third mold cavity,
wherein a height of the witness line is less than a depth of a louver, of the plurality of louvers.

13. The perforated mud flap of claim 9, wherein a second subset of the plurality of perforations bridge a first portion of the perforated mud flap that is external to the witness line and a second portion of the perforated mud flap that is internal to the witness line.

14. The perforated mud flap of claim 9, further comprising:
a plurality of louvers and a plurality of strengthening members that are separated by the plurality of perforations and formed by solidification of the polymer in the first mold cavity, the second mold cavity, and the third mold cavity.

15. A system for forming a mud flap having a plurality of perforations, the system comprising:
a first mold section for molding a front face of the mud flap, the first mold section defining:
a first parting surface, and
a first mold cavity;
a second mold section for molding a first portion of a rear face of the mud flap, the second mold section defining:
a second parting surface that is configured to abut the first parting surface,
a receiver portion that is recessed with respect to the second parting surface, and
a second mold cavity;
a first mold insert configured to fit within the receiver portion and for molding a first type of a second portion of the rear face of the mud flap, the first mold insert defining:
a third parting surface that is configured to abut the first parting surface, and
a third mold cavity that is configured to fluidly communicate with the first mold cavity and the second mold cavity and to form first indicia that has a first outline that is partially defined by a first subset of the plurality of perforations; and,
a second, alternative mold insert configured to fit within the receiver portion and for molding a second type of the second portion of the rear face of the mud flap, the second, alternative mold insert defining:
a fourth parting surface that is configured to abut the first parting surface, and
a fourth mold cavity that is configured to fluidly communicate with the first mold cavity and the second mold cavity and to form second indicia that is different than the first indicia, the second indicia having a second outline that is partially defined by a second subset of the plurality of perforations.

16. The system of claim 15, wherein, when the first mold insert is inserted into the receiver portion, a gap is defined between an outer edge of the first mold insert and a perimeter of the receiver portion, and wherein during molding the gap forms a witness line on the rear face of the mud flap that at least partially surrounds the first indicia.

17. The system of claim 15, wherein, when the second, alternative mold insert is inserted into the receiver portion, a gap is defined between an outer edge of the second, alternative mold insert and a perimeter of the receiver portion, and wherein during molding the gap forms a witness line on the rear face of the mud flap that at least partially surrounds the second indicia.

18. The system of claim 15, wherein the first indicia and the second indicia, when formed, are continuous and uninterrupted by any of the plurality of perforations.

19. The system of claim 15, wherein the first mold cavity includes a first plurality of angled portions,
wherein the second mold cavity includes a second plurality of angled portions,
wherein the third mold cavity includes a third plurality of angled portions,
wherein the fourth mold cavity includes a fourth plurality of angled portions, and
wherein the first plurality of angled portions, the second plurality of angled portions, and one of the third plurality of angled portions and the fourth plurality of angled portions cooperate to form a plurality of angled strengthening members on the mud flap.

20. The system of claim 15, wherein the first mold cavity includes a first plurality of louver-forming portions,
wherein the second mold cavity includes a second plurality of louver-forming portions,
wherein the third mold cavity includes a third plurality of louver-forming portions,
wherein the fourth mold cavity includes a fourth plurality of louver-forming portions, and
wherein the first plurality of louver-forming portions, the second plurality of louver-forming portions, and one of the third plurality of louver-forming portions and the fourth plurality of louver-forming portions cooperate to form a plurality of louvers on the mud flap that are separated by the plurality of perforations.
